(19) United States
(12) Patent Application Publication
(10) Pub. No.: US 2022/0081784 A1
(43) Pub. Date: Mar. 17, 2022

(54) CHEMICAL REACTION SYSTEM, CHEMICAL REACTION METHOD, AND VALUABLE RESOURCE PRODUCTION SYSTEM

(71) Applicant: KABUSHIKI KAISHA TOSHIBA, Tokyo (JP)

(72) Inventors: Ryota KITAGAWA, Setagaya (JP); Satoshi MIKOSHIBA, Yamato (JP); Koji MIZUGUCHI, Kawasaki (JP)

(73) Assignee: KABUSHIKI KAISHA TOSHIBA, Tokyo (JP)

(21) Appl. No.: 17/185,160

(22) Filed: Feb. 25, 2021

(30) Foreign Application Priority Data
Sep. 17, 2020 (JP) 2020-156121

(51) Int. Cl. C25B 1/23; C25B 3/07

(52) U.S. Cl. CPC C25B 1/23; C25B 3/07

(57) ABSTRACT

A chemical reaction system has: an electrochemical reaction device including a cathode configured to reduce carbon dioxide and thus generate a carbon compound, an anode configured to oxidize water and thus generate oxygen, a cathode flow path facing the cathode, an anode flow path facing the anode, and a separator between the anode and the cathode; and a dehydrogenation device configured to remove hydrogen from a first fluid introduced from the cathode flow path, the first fluid containing the hydrogen and the carbon compound, and the hydrogen being removed using oxygen.

### CROSS-REFERENCE TO RELATED APPLICATION

This application is based upon and claims the benefit of priority from Japanese Patent Application No. 2020-156121, filed on Sep. 17, 2020; the entire contents of which are incorporated herein by reference.

### FIELD

Embodiments described herein relate generally to a chemical reaction system, a chemical reaction method, and a valuable resource production system.

### BACKGROUND

In view of an energy problem and an environmental problem, an artificial photosynthesis technology is recently being developed in which carbon dioxide is electrochemically reduced to produce a storable chemical energy source by artificially using renewable energy such as sunlight in imitation of photosynthesis of plants. A chemical reaction system realizing the artificial photosynthesis technology includes an electrochemical reaction device having an anode that oxidizes water (H₂O) to generate oxygen (O₂) and a cathode that reduces carbon dioxide (CO₂) to generate a carbon compound. The anode and the cathode of an electrochemical reaction cell are connected to a power supply derived from renewable energy such as solar power generation, hydroelectric power generation, wind power generation, and geothermal power generation.

The anode has a structure in which an oxidation catalyst oxidizing water is provided on a surface of a metal base material, for example. The cathode has a structure in which a reduction catalyst reducing carbon dioxide is provided on a surface of a carbon base material, for example. The cathode obtains a reduction potential of carbon dioxide from the power supply derived from renewable energy to thereby reduce carbon dioxide, generating a carbon compound such as carbon monoxide (CO), formic acid (HCOOH), methanol (CH₃OH), methane (CH₄), ethanol (C₂H₅OH), ethane (C₂H₆), or ethylene glycol (C₂H₆O₂).

When carbon dioxide is electrochemically reduced by using the power supply such as renewable energy as described above, there is a problem, as a side reaction, that electrolysis of water occurs to cause mixing of hydrogen into a generated gas. Further, when a valuable resource is produced from the generated gas being a raw material, there is also a problem that a yield is decreased due to an influence of hydrogen.

### BRIEF DESCRIPTION OF THE DRAWINGS

FIG. 1 is a schematic diagram illustrating a configuration example of a chemical reaction system of a first embodiment.

FIG. 2 is a schematic view illustrating a configuration example of an electrochemical reaction device 1.

FIG. 3 is a schematic diagram illustrating a configuration example of a chemical reaction system of a second embodiment.

FIG. 4 is a schematic diagram illustrating a configuration example of a valuable resource production system of a third embodiment.

### DETAILED DESCRIPTION

A chemical reaction system has: an electrochemical reaction device including a cathode configured to reduce carbon dioxide and thus generate a carbon compound, an anode configured to oxidize water and thus generate oxygen, a cathode flow path facing the cathode, an anode flow path facing the anode, and a separator between the anode and the cathode; and a dehydrogenation device configured to remove hydrogen from a first fluid introduced from the cathode flow path, the first fluid containing the hydrogen and the carbon compound, and the hydrogen being removed using oxygen.

Hereinafter, embodiments will be described with reference to the drawings. In respective embodiments described below, substantially the same components are denoted by the same codes, and description thereof is sometimes partially omitted. The drawings are schematic, and a relationship between a thickness and a planar size, thickness proportions of the respective portions, and so on are sometimes different from actual ones.

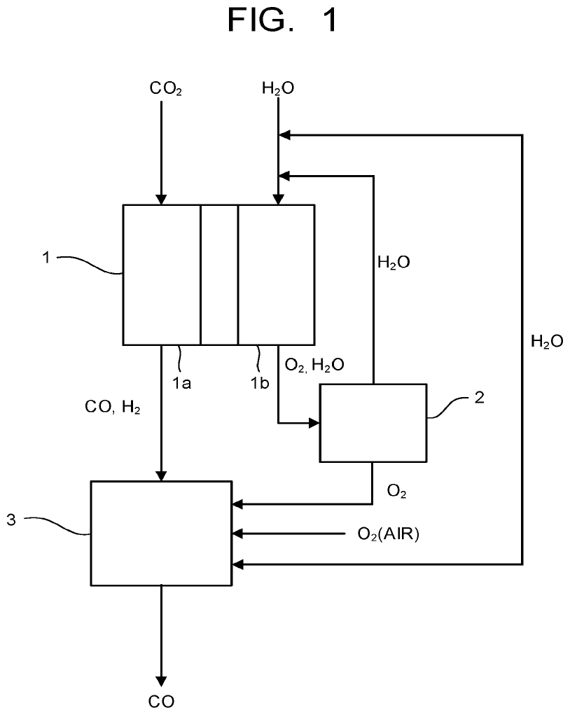

FIG. 1 is a schematic diagram illustrating a configuration example of a chemical reaction system of a first embodiment. The chemical reaction system illustrated in FIG. 1 has an electrochemical reaction device 1, a gas-liquid separator 2, and a dehydrogenation device 3.

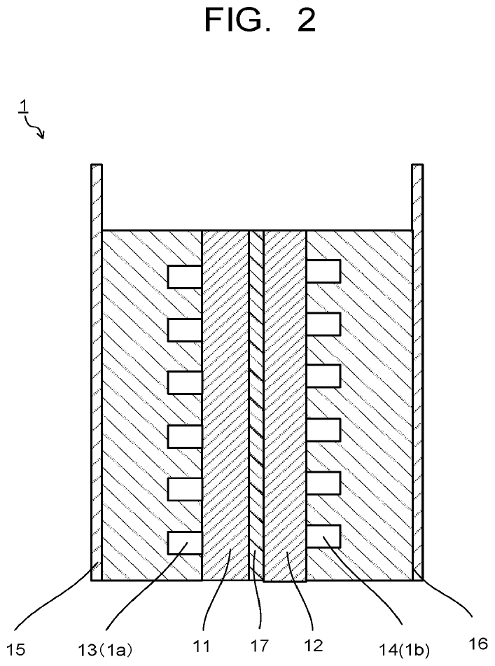

FIG. 2 is a schematic view illustrating a configuration example of the electrochemical reaction device 1. The electrochemical reaction device 1 has a cathode (reduction electrode) 11, a cathode flow path 13 distributing a gas containing carbon dioxide in a manner to be in contact with the cathode 11, an anode flow path 14 distributing an electrolytic solution containing water or vapor in a manner to be in contact with an anode 12, a cathode current collector plate 15 electrically connected to the cathode 11, an anode current collector plate 16 electrically connected to the anode 12, and a separator 17 placed between the cathode 11 and the anode 12.

The electrolytic solution includes, for example, a solution containing water, and, for example, an aqueous solution containing an arbitrary electrolyte. This solution is preferably a solution promoting an oxidation reaction of water. Examples of the aqueous solution containing the electrolyte include an aqueous solution containing a phosphoric acid ion (PO₄²⁻), a boric acid ion (BO₃³⁻), a sodium ion (Na⁺), a potassium ion (K⁺), a calcium ion (Ca²⁺), a lithium ion (Li⁺), a cesium ion (Cs⁺), a magnesium ion (Mg²⁺), a chloride ion (Cl⁻), a hydrogen carbonate ion (HCO₃⁻), a carbonate ion (CO₃⁻), a hydroxide ion (OH⁻), or the like.

The cathode 11 is an electrode for generating a reduction product such as a carbon compound by reducing carbon dioxide supplied as a gas. The cathode 11 includes a reduction catalyst for generating a carbon compound by a reduction reaction of carbon dioxide. As the reduction catalyst, a material decreasing activation energy for reducing carbon dioxide is used. In other words, there is used the material decreasing overvoltage when a carbon compound is generated by a reduction reaction of carbon dioxide.

As the reduction catalyst, for example, a metal material or a carbon material can be used. Examples of the usable metal material include a metal such as gold (Au), aluminum (Al), copper (Cu), silver (Ag), platinum (Pt), palladium (Pd), zinc (Zn), mercury (Hg), indium (In), nickel (Ni), or titanium (Ti), an alloy containing such a metal, and so on. Examples of the usable carbon material include graphene, carbon nanotube (CNT), fullerene, ketjen black, and so on. The reduction catalyst is not limited to the above and, for example, a metal complex such as a ruthenium (Ru) complex or a rhenium (Re) complex, or an organic molecule having an imidazole skeleton or a pyridine skeleton may be used as the reduction catalyst. The reduction catalyst may be a mixture of a plurality of materials. The cathode 11 may have a structure in which the reduction catalyst of a thin film shape, a lattice shape, a particle shape, a wire shape, or the like is provided on a conductive base material, for example.

The carbon compound generated by the reduction reaction in the cathode 11 is different by the kind or the like of the reduction catalyst, and examples thereof include carbon monoxide (CO), formic acid (HCOOH), methane (CH₄), methanol (CH₃OH), ethane (C₂H₆), ethylene (C₂H₄), ethanol (C₂H₅OH), formaldehyde (HCHO), ethylene glycol (C₂H₆O₂), and so on. Further, in the cathode 11, a side reaction generating hydrogen by the reduction reaction of water may occur simultaneously with the reduction reaction of carbon dioxide.

The anode 12 is an electrode oxidizing a substance in an electrolytic solution or a substance to be oxidized such as an ion. For example, the anode oxidizes water (H₂O) to generate oxygen or a hydrogen peroxide solution, or oxidizes a chloride ion (Cl⁻) to generate chlorine. The anode 12 includes an oxidation catalyst of a substance to be oxidized such as water. As the oxidation catalyst, a material decreasing activation energy at a time of oxidation of the substance to be oxidized, that is, a material decreasing reaction overvoltage is used.

Examples of the oxidation catalyst material include a metal such as ruthenium (Ru), iridium (Ir), platinum (Pt), cobalt (Co), nickel (Ni), iron (Fe), or manganese (Mn). Further, a binary metal oxide, a ternary metal oxide, a quaternary metal oxide, or the like can be used. Examples of the binary metal oxide include a manganese oxide (Mn—O), an iridium oxide (Ir—O), a nickel oxide (Ni—O), a cobalt oxide (Co—O), an iron oxide (Fe—O), a tin oxide (Sn—O), an indium oxide (In—O), a ruthenium oxide (Ru—O), and so on. Examples of the ternary metal oxide include Ni—Fe—O, Ni—Co—O, La—Co—O, Ni—La—O, Sr—Fe—O, and so on. Examples of the quaternary metal oxide include Pb—Ru—Ir—O, La—Sr—Co—O, and so on. The oxidation catalyst is not limited to the above, and a metal hydroxide containing cobalt, nickel, iron, manganese, or the like, and a metal complex such as a ruthenium (Ru) complex or an iron (Fe) complex can be used as the oxidation catalyst. Further, a plurality of materials may be mixed and used together.

The anode 12 may be constituted by a composite material containing both the oxidation catalyst and a conductive material. Examples of the conductive material include: a carbon material such as carbon black, activated carbon, fullerene, carbon nanotube, graphene, ketjen black, or diamond; a transparent conductive oxide such as an indium tin oxide (ITO), a zinc oxide (ZnO), a fluorine-doped tin oxide (FTO), an aluminum-doped zinc oxide (AZO), or an antimony-doped tin oxide (ATO); a metal such as Cu, Al, Ti, Ni, Ag, W, Co, or Au; and an alloy containing at least one of the above metals. The anode 12 may have a structure in which an oxidation catalyst of a thin film shape, a lattice shape, a particle shape, a wire shape, or the like is provided on a conductive base material, for example. As the conductive base material, a metal material that includes titanium, a titanium alloy, or stainless steel, for example, is used.

The cathode flow path 13 faces the cathode 11. The cathode flow path 13 functions as a first accommodation part la illustrated in FIG. 1. The cathode flow path 13 is provided in a flow path plate, for example.

The anode flow path 14 faces the anode 12. The anode flow path 14 functions as a second accommodation part lb illustrated in FIG. 1. The anode flow path 14 is provided in a flow path plate, for example.

The separator 17 separates the first accommodation part 1a and the second accommodation part 1b and can separate substances generated in the first accommodation part 1a and the second accommodation part 1b. As the separator 17, a film that can selectively transmit an anion, a cation, or the like can be used. Further, a film that can transmit both the anion and the cation may be used.

As the separator 17, there can be used an ion exchange membrane such as, for example, NEOSEPTA (registered trademark) of ASTOM Corporation, Selemion (registered trademark), Aciplex (registered trademark) of AGC Inc., Fumasep (registered trademark), Fumapem (registered trademark) of Fumatech GmbH, Nafion (registered trademark) being a fluorocarbon resin made by sulfonating and polymerizing tetrafluoroethylene of E.I. du Pont de Nemours and Company, lewabrane (registered trademark) of LANXESS AG, IONSEP (registered trademark) of TONTECH Inc., Mustang (registered trademark) of PALL Corporation, ralex (registered trademark) of mega Corporation, Gore-Tex (registered trademark) of Gore-Tex Co., Ltd. or the like. Besides, the ion exchange membrane may be composed using a film having hydrocarbon as a basic skeleton or a film having an amine group in anion exchange. Further, by application of a bipolar membrane obtained by stacking a cation exchange membrane and an anion exchange membrane, the electrolytic solutions can be used while stably keeping pHs in the first and second accommodation parts.

For the separator 17, other than the ion exchange membrane, there can be used, for example, a silicone resin, a fluorine-based resin (perfluoroalkoxyalkane (PFA), perfluoroethylene propene copolymer (FEP), polytetrafluoroethylene (PTFE), ethylene-tetrafluoroethylene copolymer (ETFE), polyvinylidene fluoride (PVDF), polychlorotrifluoroethylene (PCTFE), ethylene-chlorotrifluoroethylene copolymer (ECTFE), or the like), polyethersulfone (PES), a ceramics porous film, a glass filter, a filling material obtained by filling agar or the like, an insulating porous body such as zeolite or an oxide, and so on. In particular, a hydrophilic porous film never causes clogging due to air bubbles and is thus preferable as the separator 17.

The cathode 11, the anode 12, the cathode flow path 13, the anode flow path 14, and the separator 17 constitute one electrochemical reaction cell. The electrochemical reaction device 1 may include a stack having a plurality of electrochemical reaction cells stacked integrally. By the above-described stack, a reaction amount of carbon dioxide per unit area can be increased, so that a throughput can be increased. The number of stacks of the electrochemical cells is preferably 10 or more and 150 or less, for example.

A temperature of the electrochemical reaction device 1 is preferably set to a temperature that does not vaporize an electrolytic solution in a range from a room temperature (for example, 25° C.) to 150° C. The temperature is more preferably a temperature in a range from 40° C. to 150° C. and is further preferably a temperature in a range from 60° C. to 150° C. A cooling device such as a chiller is necessary in order to obtain a temperature lower than the room temperature, which may cause a decrease in energy efficiency of the comprehensive system. When the temperature exceeds 150° C., water of the electrolytic solution changes to vapor, thereby increasing a resistance, so that an electrolytic efficiency may be decreased.

A current density of the cathode 11 is not particularly limited, but the current density is preferable to be high in order to increase a generation amount of the reduction product per unit area. The current density is preferably 100 mA/cm² or more and 1.5 A/cm² or less, and further preferably 300 mA/cm² or more and 700 mA/cm² or less. When the current density is less than 100 mA/cm², the generation amount of the reduction product per unit area is low and a large area is required. When the current density exceeds 1.5A/cm², a side reaction of hydrogen generation increases, thereby decreasing a concentration of the reduction product. If increasing the current density also increases Joule heat, the temperature is raised to a temperature higher than an appropriate one, and thus a cooling mechanism may be provided in the electrochemical reaction device 1 or in its neighborhood. A water-cooling type or an air-cooling type cooling mechanism can be used. Even when the temperature of the electrochemical reaction device 1 is higher than the room temperature, that temperature is acceptable as long as it is 150° C. or less.

Pressures inside the cathode flow path 13 and the anode flow path 14 are preferable to be pressures that do not liquefy carbon dioxide, and concretely, the pressures are preferably arranged in a range of 0.1 MPa or more and 6.4 MPa or less. If the pressure in the accommodation part is less than 0.1 MPa, a reduction reaction efficiency of carbon dioxide may be decreased. If the pressure in the accommodation part exceeds 6.4 MPa, carbon dioxide is liquefied and the reduction reaction efficiency of carbon dioxide may be decreased. Note that a differential pressure between the cathode flow path 13 and the anode flow path 14 may cause breakage or the like of the separator 17. Thus, the difference between pressures (differential pressure) between the cathode flow path 13 and the anode flow path 14 is preferably set to 0.5 MPa or less.

The cathode current collector plate 15 and the anode current collector plate 16 are electrically connected to a power supply (not shown). The power supply is able to supply electric power to make the electrochemical reaction device 1 cause the oxidation reduction reaction, and is electrically connected to the cathode 11 and the anode 12. The reduction reaction by the cathode 11 and the oxidation reaction by the anode 12 are performed by using electric energy supplied from the power supply. The power supply and the cathode 11 as well as the power supply and the anode 12 are connected, for example, by wirings. Electric equipment such as an inverter, a converter, a battery may be installed between the electrochemical reaction device 1 and the power supply as necessary. A drive system of the electrochemical reaction device 1 may be a constant-voltage system or may be a constant-current system.

The power supply may be a normal commercial power supply, a battery, or the like, or may be a power supply that supplies electric energy obtained by converting renewable energy. Examples of those power supply include a power supply that converts kinetic energy or potential energy such as wind power, water power, geothermal power, or tidal power to electric energy, a power supply such as a solar cell with a photoelectric conversion element that converts light energy to electric energy, a power supply such as a fuel cell or a storage battery that converts chemical energy to electric energy, and a power supply such as an apparatus that converts vibrational energy of sound or the like to electric energy. The photoelectric conversion element has a function of performing charge separation by emitted light energy of sunlight or the like. Examples of the photoelectric conversion element include a pin-junction solar cell, a pn-junction solar cell, an amorphous silicon solar cell, a multijunction solar cell, a single crystal silicon solar cell, a polycrystalline silicon solar cell, a dye-sensitized solar cell, an organic thin-film solar cell, and so on.

The gas-liquid separator 2 is connected to the anode flow path 14 via a flow path such as a piping. The gas-liquid separator 2 separates the electrolytic solution contained in a fluid introduced from the anode flow path 14. Thereby, the fluid supplied from the anode flow path 14 is separated into a gas and a liquid, the gas is supplied to the dehydrogenation device 3, and the liquid is supplied to the anode flow path 14. The gas-liquid separator 2 may be connected to the dehydrogenation device 3 via a flow path such as a piping. The gas-liquid separator 2 is not necessarily required to be provided.

The dehydrogenation device 3 is connected to the cathode flow path 13 via a flow path such as a piping. The dehydrogenation device 3 removes hydrogen in the gas introduced from the first accommodation part la (cathode flow path 13), by using oxygen. Hydrogen is removed by generating water by a dehydrogenation reaction between hydrogen and oxygen, for example. The above-described dehydrogenation reaction can be performed, for example, by using a catalyst provided in the accommodation part of gas described above.

Next, a chemical reaction method example using the chemical reaction system of this embodiment will be described. First, a gas containing carbon dioxide is introduced into the cathode flow path 13 and an electrolytic solution containing water or vapor, for example, is introduced into the anode flow path 14. Further, a voltage is applied between the cathode 11 and the anode 12 to supply a current, thereby generating an oxidation reaction of water in the anode 12 that is in contact with the electrolytic solution or the vapor. Concretely, as shown in the formula (1) below, by oxidizing water, oxygen (O₂) and hydrogen ions (H⁺) are generated. Note that each introduction may be performed by using a pump connected to each flow path.

2H₂O→4H⁺+O₂+4e⁻ (1)

H⁺ generated in the anode 12 reaches the neighborhood of the cathode 11 via the separator 17. By an electron (e⁻) based on the current supplied from the power supply to the cathode 11 and H⁻ having moved to the neighborhood of the cathode 11, a reduction reaction of carbon dioxide occurs. In a case where carbon monoxide is generated by the reduction reaction, for example, as shown by the formula (2) below, carbon dioxide supplied from the cathode flow path 13 to the cathode 11 is reduced to generate carbon monoxide.

2CO₂+4H⁺+4e⁺→2CO+2H₂O (2)

Further, in the neighborhood of the cathode 11, as shown in the formula (3) below, water and carbon dioxide is reduced to generate carbon monoxide and hydroxide ions. The hydroxide ions diffuse in the neighborhood of the cathode 11, and as shown in the formula (4) below, the hydroxide ions are oxidized to generate oxygen. Further, as a side reaction, water is sometimes reduced to generate hydrogen.

2CO₂+2H₂O+4e⁻→2CO+4OH⁻ (3)

4OH⁻→2H₂O+O₂+4e⁻ (4)

Oxygen generated by the anode 12 is introduced from the anode flow path 14 together with the electrolytic solution or the vapor and supplied to the gas-liquid separator 2. The gas-liquid separator 2 separates the gas and the liquid to separate oxygen and the electrolytic solution or the vapor. The separated electrolytic solution or vapor is supplied to the anode flow path 14 again. Thereby, the electrolytic solution or the vapor is circulated.

Oxygen separated by the gas-liquid separator 2 is supplied to the dehydrogenation device 3. At this time, other than the separated oxygen, oxygen contained in air or oxygen separated and collected from the air can be further supplied to the dehydrogenation device 3. Further, by the cathode 11, gas components of a carbon dioxide reduced substance and hydrogen of a side reactant are also supplied to the dehydrogenation device 3.

The hydrogenation unit 3 generates water by chemically reacting hydrogen and oxygen to thereby remove hydrogen contained in the fluid introduced from the cathode 13. The chemical reaction between hydrogen and oxygen is represented by the formula (5) below.

2H₂+O₂→2H₂O (5)

When carbon dioxide is contained in the fluid introduced from the cathode flow path 13 or the anode flow path 14, the dehydrogenation device 3 can remove hydrogen by a chemical reaction between hydrogen and carbon dioxide. The chemical reaction between hydrogen and carbon dioxide is represented by the formula (6) below.

CO₂+H₂→CO+H₂O (6)

As described above, in the chemical reaction system of this embodiment, hydrogen contained together with the carbon compound in the fluid introduced from the cathode flow path 13 is removed by using oxygen. Thereby, a purity of the reduction product can be increased.

To the reaction between hydrogen and oxygen, a thermal-chemical method using a catalytic reaction or an electrochemical method using an electrochemical catalyst is applicable. In such a case, water generated by a dehydrogenation reaction can be effectively used by being supplied via the gas-liquid separator 2 or supplied directly to the anode flow path 14. For example, it is acceptable to provide a flow path such as a piping for supplying generated water from the dehydrogenation device 3 to the anode flow path 14.

Since the reaction represented by the formula (5) is an exothermic reaction, obtained energy can be utilized as motive power in the system. For example, when a fuel cell is used as the dehydrogenation device 3, power generation is possible by a reaction between hydrogen and oxygen, so that obtained electric power can be used as motive power of the system to thereby increase an efficiency of the system. Normally, as a method of removing hydrogen in a gas, there is a low-temperature separation method, a membrane separation method, a pressure swing absorption method (PSA), and so on, and separation by the above method is accompanied by energy consumption at a time of separation, by cooling or pressuring operation. In this embodiment, oxygen contained in the fluid that is supplied from the gas-liquid separator 2 as the reaction gas at the time of dehydrogenation is used, and water and energy generated by the hydrogenation reaction are reused, so that it is possible to provide a low-cost system in which a utilization efficiency of a substance is high.

### Second Embodiment

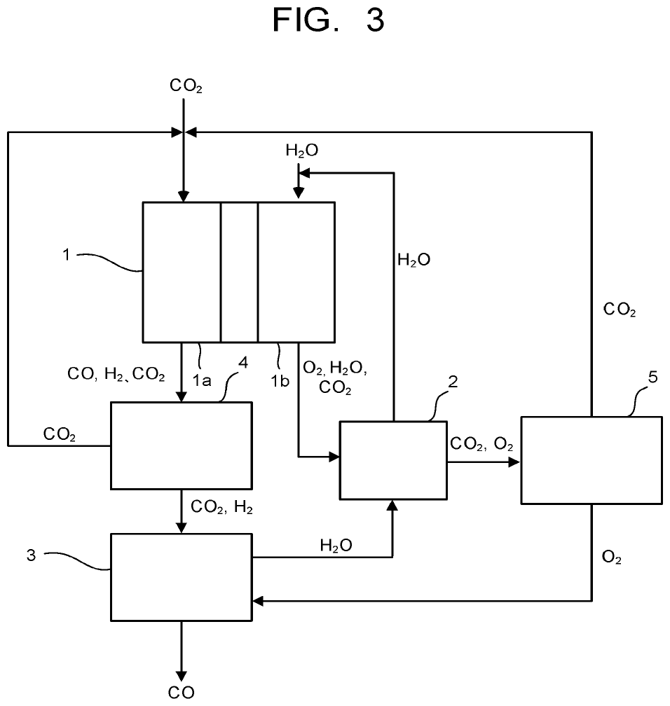

FIG. 3 is a diagram illustrating a configuration example of a chemical reaction system of a second embodiment. The chemical reaction system illustrated in FIG. 3 has an electrochemical reaction device 1, a gas-liquid separator 2, and a dehydrogenation device 3. Concrete configurations of the electrochemical reaction device 1, the gas-liquid separator 2, and the dehydrogenation device 3 are similar to those of the first embodiment and are as described above.

The chemical reaction system of the second embodiment further has a carbon dioxide separator 4 and a carbon dioxide separator 5.

The carbon dioxide separator 4 connects a cathode flow path 13 and the dehydrogenation device 3. The above are connected via a flow path such as a piping, for example. The carbon dioxide separator 4 separates carbon dioxide contained in a fluid introduced from the cathode flow path 13. Thereby, carbon dioxide can be separated from a mixed gas of a carbon compound such as carbon monoxide, hydrogen, and carbon dioxide from the cathode flow path 13.

The carbon dioxide separator 5 is connected to an anode flow path 14 via the gas-liquid separator 2. The above are connected via a flow path such as a piping, for example. The carbon dioxide separator 5 separates carbon dioxide contained in a fluid supplied from the gas-liquid separator 2. Thereby, carbon dioxide can be separated from a mixed gas of carbon dioxide and oxide from the gas-liquid separator 2.

To the carbon dioxide separator 4 and the carbon dioxide separator 5, for example, a carbon dioxide chemical absorption separation device, a carbon dioxide physical absorption separation device, a carbon dioxide membrane separation device, and so on are applicable. As the carbon dioxide chemical absorption separation device, there can be cited a device that separates and collects carbon dioxide from an absorbing liquid by using an amine solution as the absorbing liquid, letting the absorbing liquid absorb carbon dioxide in the introduced gas, and then heating the resultant. It is also possible to constitute a chemical absorption separation device by using a solid absorbent with amines, which are a chemical absorbent, supported on a porous support, in place of using amines in the carbon dioxide chemical absorption separation device as a solution.

As the carbon dioxide physical adsorption separation device, there can be cited a device that adsorbs carbon dioxide or oxygen on an adsorbent such as zeolite or molecular sieve and separates a main component or an impurity component by changing a pressure, a temperature, or the like. As the carbon dioxide membrane separation device, there can be cited a device that selectively separates and collects carbon dioxide by using a separation membrane containing activated carbon, molecular sieve, or the like, a polymer membrane such as a molecular gate membrane, or the like.

A gas component introduced from the gas-liquid separator 2 is supplied to the carbon dioxide separator 5 and an oxygen gas from the carbon dioxide separator 5 is supplied to the dehydrogenation device 3. Further, carbon dioxide separated by the carbon dioxide separator 4 and the carbon dioxide separator 5 can be supplied to the cathode flow path 13. For example, the cathode flow path 13 and the carbon dioxide separator 4 may be connected and a flow path such as a piping supplying separated carbon dioxide from the carbon dioxide separator 4 to the cathode flow path 13 may be provided. Further, it is acceptable to connect the cathode flow path 13 and the carbon dioxide separator 5 and to provide a flow path such as a piping supplying separated carbon dioxide from the carbon dioxide separator 5 to the cathode flow path 13.

According to the chemical reaction system of the second embodiment, it is possible to provide an aimed system in which a carbon dioxide reduced substance is highly purified and a utilization efficiency of substance is enhanced, even in a case where unreacted carbon dioxide in the cathode flow path 13 of the electrochemical reaction device 1 is introduced as the gas component and even in a case where carbon dioxide in the cathode flow path 13 moves to the anode flow path 14 by crossover and is introduced from the anode flow path 14.

### Third Embodiment

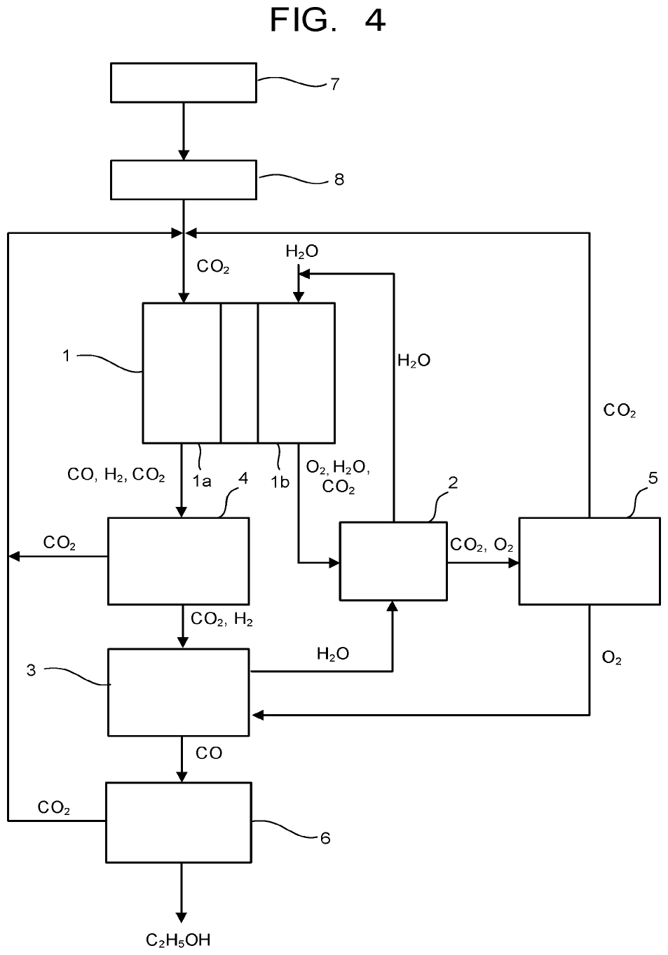

In a third embodiment, a valuable resource production system using a carbon compound generated in the chemical reaction system of the first embodiment to the third embodiment will be described with reference to FIG. 4. FIG. 4 is a diagram illustrating a configuration example of a valuable resource production system of the third embodiment.

The valuable resource production system illustrated in FIG. 4 has a reaction device 6 in addition to the chemical reaction system illustrated in FIG. 3. The valuable resource production system illustrated in FIG. 4 generates a high-purity carbon compound such as carbon monoxide by the chemical reaction system of the aforementioned embodiment. Further, the valuable resource production system can produce a valuable resource by the reaction device 6 by using the carbon compound such as carbon monoxide as a raw material. Concrete configurations of an electrochemical reaction device 1, a gas-liquid separator 2, a dehydrogenation device 3, a carbon dioxide separator 4, and a carbon dioxide separator 5 are similar to those of the second embodiment and are as described above. Note that the configuration is not limited to the above and a reaction device 6 may be applied to the configuration illustrated in FIG. 1.

To a cathode flow path 13 is supplied a carbon dioxide gas separated and collected from an exhaust gas of a carbon dioxide discharge source 7 by a carbon dioxide separator 8. The above are connected via a flow path such as a piping, for example. Examples of the carbon dioxide discharge source 7 include various incinerators and a facility having an incinerator such as a thermal power station and a garage furnace, a steel plant, a facility having a blast furnace, and so on. The carbon dioxide discharge source 7 may be various factories or the like which generate carbon dioxide, other than the above, and is not particularly limited. To the carbon dioxide separator 8, the same configuration of the carbon dioxide separator 4 or the carbon dioxide separator 5 can be applied, and explanation thereof will be omitted here.

The reaction device 6 is connected to a dehydrogenation device 3, and a fluid containing a carbon compound such as carbon monoxide introduced from the dehydrogenation device 3 is supplied to the reaction device 6. The above are connected via a flow path such as a piping, for example. At this time, containers such as tanks storing the carbon compounds introduced from the dehydrogenation device 3 may be provided in gas discharge parts of the dehydrogenation device 3 and the reaction device 6.

The reaction device 6 produces a valuable resource by using the high-purity carbon compound introduced from the dehydrogenation device 3 as a raw material. The carbon compound introduced from the dehydrogenation device 3 may be directly used or consumed, but providing the reaction device 6 in a later stage of the chemical reaction system enables production of a variable resource having a high added value.

Reactions of a reduction product by the reaction device 6 include reactions such as a chemical reaction, an electrochemical reaction, and a biological conversion reaction using an organism such as algae, enzyme, yeast, or bacteria. The existence of hydrogen in a material gas at a time of reaction may induce a decrease in reaction efficiency or a decrease in purity of a product. In the biological conversion reaction in particular, a high-purity carbon monoxide gas is sometimes suitable as the material gas of the reaction device 6 generating fuel or a chemical substance such as methanol, ethanol, or butanol by anaerobic microorganisms. In contrast, in the valuable resource production system of this embodiment, since hydrogen is removed by the dehydrogenation device 3 to thereby increase the purity of the reduced product, a decrease in reaction efficiency and a decrease in purity of the valuable resource can be suppressed.

In a case where the chemical reaction, the electrochemical reaction, or the biological conversion reaction by bacteria or the like is performed at a temperature higher than a room temperature, at least one parameter of the reaction efficiency and a reaction rate sometimes improves. When the carbon monoxide gas introduced into the reaction device 6 is set to a temperature of 60° C. or more and 150° C. or less, it is possible to improve an energy conversion efficiency of the chemical reaction system. The reaction of the biological conversion reaction by bacteria or the like progresses most efficiently at a temperature around 80° C., and thus when the reduction product is supplied to the reaction device 6 at a temperature of 60° C. or more and 100° C. or less, the efficiency further improves. The reaction device 6 may be heated or pressurized by applying energy thereto from outside, in order to improve the reaction efficiency.

Examples of the valuable resource obtained from the reaction device 6 include alcohols such as ethanol and butanol, phosgene being a raw material of isocyanates, and a metal product of iron or the like. At a time of synthesizing these valuable resources, a high-purity carbon compound is sometimes suitable, and usage of the high-purity carbon compound obtained by removing hydrogen by the chemical reaction system enables efficient production of the valuable resources.

Sometimes a carbon compound such as carbon monoxide is used with a reducing agent in the reaction device 6 and carbon dioxide is generated as a result of a reaction. In this case, by separating and retrieving generated carbon dioxide and supplying the carbon dioxide to the cathode flow path 13 of the electrochemical reaction device 1 again, it becomes possible to construct a system in which a utilization ratio of a substance is improved.

Note that the above-described configurations in the embodiments are applicable in combination, and parts thereof are also replaceable. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A chemical reaction system comprising:
an electrochemical reaction device including
a cathode configured to reduce carbon dioxide and thus generate a carbon compound,
an anode configured to oxidize water and thus generate oxygen,
a cathode flow path facing the cathode,
an anode flow path facing the anode, and
a separator between the anode and the cathode; and
a dehydrogenation device configured to remove hydrogen from a first fluid introduced from the cathode flow path, the first fluid containing the hydrogen and the carbon compound, and the hydrogen being removed using oxygen.

2. The chemical reaction system according to claim 1, further comprising
a first carbon dioxide separator connecting the cathode flow path and the dehydrogenation device and configured to separate carbon dioxide from the first fluid.

3. The chemical reaction system according to claim 2, further comprising
a first flow path through which the separated carbon dioxide is supplied from the first carbon dioxide separator to the cathode flow path.

4. The chemical reaction system according to claim 2, wherein
the first carbon dioxide separator includes a carbon dioxide physical absorption separation device, a carbon dioxide chemical absorption separation device, or a carbon dioxide membrane separation device.

5. The chemical reaction system according to claim 1, further comprising
a gas-liquid separator configured to separate an electrolytic solution from a second fluid introduced from the anode flow path, wherein
the dehydrogenation device is configured to remove the hydrogen from the first fluid by chemically reacting the hydrogen with oxygen in the second fluid introduced from the gas-liquid separator to generate water.

6. The chemical reaction system according to claim 1, further comprising:
a gas-liquid separator configured to separate an electrolytic solution from a second fluid introduced from the anode flow path; and
a second carbon dioxide separator configured to separate carbon dioxide from the second fluid introduced from the gas-liquid separator, wherein
the dehydrogenation device is configured to remove the hydrogen by chemically reacting the hydrogen with oxygen in the second fluid introduced from the second carbon dioxide separator to generate water.

7. The chemical reaction system according to claim 6, further comprising
a second flow path connecting the cathode flow path and the second carbon dioxide separator and configured to supply the separated carbon dioxide from the second carbon dioxide separator to the cathode flow path.

8. The chemical reaction system according to claim 6, wherein
the second carbon dioxide separator includes a carbon dioxide physical absorption separation device, a carbon dioxide chemical absorption separation device, or a carbon dioxide membrane separation device.

9. The chemical reaction system according to claim 1, wherein
the dehydrogenation device is configured to remove the hydrogen by chemically reacting the hydrogen with oxygen in air or oxygen collected from the air to generate water.

10. The chemical reaction system according to claim 5, further comprising
a third flow path through which the generated water is supplied from the dehydrogenation device to the anode flow path.

11. A chemical reaction method comprising:
introducing a gas containing carbon dioxide into a cathode flow path facing a cathode provided in an electrochemical reaction device and introducing an electrolytic solution containing water or vapor into an anode flow path facing an anode provided in the electrochemical reaction device;
applying a voltage between the cathode and the anode to reduce the carbon dioxide by the cathode and thus generate a carbon compound and to oxidize water by the anode and thus generate oxygen; and
removing hydrogen from a first fluid introduced from the cathode flow path, the first fluid containing the hydrogen and the carbon compound, and the hydrogen being removed using oxygen.

12. A valuable resource production system comprising:
the chemical reaction system according to claim 1; and
a reaction device configured to produce a valuable resource by a reaction using the carbon compound from the dehydrogenation device.

13. The valuable resource production system according to claim 12, wherein
the reaction device is configured to produce the valuable resource by a biological conversion reaction using the carbon compound.
